(19) United States
(12) Patent Application Publication
(10) Pub. No.: US 2022/0114625 A1
(43) Pub. Date: Apr. 14, 2022

(54) VENUE EXPERIENCE ECONOMY ENGAGEMENT SYSTEMS AND METHODS

(71) Applicant: Grip Places Inc., Parker, CO (US)

(72) Inventors: Jon FAIRBAND, Parker, CO (US); Anthony HILDOER, Parker, CO (US)

(21) Appl. No.: 17/383,199

(22) Filed: Jul. 22, 2021

Related U.S. Application Data
(60) Provisional application No. 63/055,298, filed on Jul. 22, 2020.

(51) Int. Cl. G06Q 30/02; G06V 20/52

(52) U.S. Cl. CPC G06Q 30/0282; G06V 20/53; G06Q 30/0205

(57) ABSTRACT

Methods, systems, and devices for venue rating systems and matching consumers with venues that track the consumer's preferences for venue vibes and other criteria are described. The systems and methods include multiple components, include use of real-time video inputs, which allow consumers and businesses to analyze a venue in real-time and help measure and/or determine an experience or other criteria associated with that venue, use of venue level experience metrics, which enable the business associated with the venue to describe an intended experience, vibe and/or other criteria associated with the venue, and use of product and/or service level experience metrics, which allow similar discussion as the venue level experience metrics, but typically on a smaller scale.

### CROSS REFERENCE TO RELATED APPLICATION

This application claims priority to and the benefit of U.S. Provisional Patent Application No. 63/055,298, filed Jul. 22, 2020, and entitled VENUE EXPERIENCE ECONOMY ENGAGEMENT SYSTEMS AND METHODS, the disclosure of which is incorporated herein by reference in its entirety.

### BACKGROUND

The use of computer systems and computer-related technologies continues to increase at a rapid pace. This increased use of computer systems has influenced the advances made to computer-related technologies. Computer systems have increasingly become an integral part of the business world and the activities of individual consumers. Computer systems may be used to carry out several business, industry, and academic endeavors.

In the retail store front industry, which includes gyms, restaurants, nightclubs, and a variety of business and social venues, an attempt has been made to analyze experience in terms of very linear, aggregate information, such as star ratings that are generated using various computer systems. Star ratings as they are currently implemented require someone to summarize an overall experience into a single, linear description (e.g., number of stars). For example, a restaurant may have long waits, but the food and atmosphere excellent, so it is sometimes difficult to represent the negative experience with the long wait time as well as the positive experience with the food and atmosphere with a single star rating. In another example, two restaurants may offer great experiences, but those experiences may be completely different. In a star rating system, both restaurants would have the same star rating but would appeal to different people. Furthermore, star ratings are aggregate averages of the general population and are thus not personal.

Opportunities existing for improvements in the ways venues are rated and consumers are matched with venues that meet their preferences. Such improvements may take advantage of advancements in computer systems and computer-related technologies.

### SUMMARY

The described techniques relate to improved methods, systems, devices, or apparatuses that provide, among other things, improvements for venue ratings, venue recommendations, determining patron waiting times, menu feedback at venues, and determine vibes and patron experiences at venues.

One aspect of the present disclosure relates to a method for rating venues. The method includes receiving real-time video footage of a venue, receiving patron input about a personal visit to the venue, receiving venue input about at least one of intended patron experience and intended venue attributes, determining one or more descriptive vibes related to the venue based on the video footage, patron input, and venue input, and distributing the one or more vibes.

The method may also include associating the patron input with the determined one or more vibes. The method may include recommending other venues to the patron that include the determined one or more vibes. The one or more vibes may each represent a positively oriented adjective commonly used to describe experience from an emotional perspective. The method may include determining wait time using the real-time video footage of the venue. The venue may include at least one of a restaurant, a gym, a bar, a store, and a dance club. The method may include determining a bounce rate at the venue based on patron dwell time at the venue. The method may include using the real-time video footage of the venue as a factor for determining the bounce rate. The method may include determining demographics at the venue based on the real-time video footage of the venue. After determining the one or more vibes, the method may include identifying visual indicators from the real-time video footage of the venue related to the determined one or more vibes.

Another aspect of the present disclosure relates to a method for recommending venues. The method includes receiving patron input about a personal visit to a venue, receiving venue input from the venue about at least one of intended patron experience and intended venue attributes, determining one or more descriptive vibes related to the venue based on the patron input and venue input, associating the patron input with the determined one or more vibes, and recommending other venues to the patron that include the determined one or more vibes. The method may also include receiving real-time video footage of the venue and determining the one or more vibes is also based on the real-time video footage.

A further aspect of the present disclosure relates to a method for determining wait times at a venue. The method includes receiving real-time video footage of the venue, tracking individual patrons in wait areas of the venue, determining an amount of wait time for the individual patrons based on the tracking, and distributing the wait times in association with the venue.

A further aspect relates to a method for determining dwell time of a patron at a venue. The method includes receiving real-time video footage of the venue, tracking individual patrons entering and exiting at least one of an entrance or exit of the venue, determining an amount of time the individual patrons are located inside the venue based on the tracking, receiving information from the venue about the individual patrons' activities while located inside the venue, and determining whether the individual patrons' visit to the venue meets criteria for a meaningful interaction.

Another aspect relates to a method for determining demographics of visitors to a venue. The method includes receiving real-time video footage of the venue, tracking individual patrons entering and exiting at least one of an entrance or exit of the venue, and determining at least one characteristic of the individual patrons based on the tracking, the at least one characteristic relating to demographics of the individual patrons. The at least one characteristic of the individual patrons may include at least one of age, race, gender, social status, occupation, income, level of education, marriage status, and sexual orientation.

Another aspect relates to a method for determining atmosphere conditions at a venue. The method includes receiving real-time video footage of the venue, receiving patron input about a personal visit to the venue, determining at least one of one or more descriptive vibes related to the venue based on the video footage and patron input, and distributing the one or more vibes associated with the venue.

The method may also include associating the patron input with the determined one or more vibes and recommending other venues to the patron that include the determined one or more vibes. The method may include detecting at least one of activities, décor, services being rendered, number of people, size of venue, and dress of patrons in the real-time video footage and associating the same with the determined one or more vibes.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a system that supports venue experience determinations in accordance with aspects of the present disclosure.

FIGS. 2A and 2B illustrate an example of a system architecture that supports venue experience determinations in accordance with aspects of the present disclosure.

FIG. 3 illustrates an example of portions of the system architecture shown in FIGS. 2A and 2B in accordance with aspects of the present disclosure.

FIG. 4 illustrates an example of portions of the system architecture shown in FIGS. 2A and 2B in accordance with aspects of the present disclosure.

FIG. 5 illustrates an example of portions of the system architecture shown in FIGS. 2A and 2B in accordance with aspects of the present disclosure.

FIG. 6 illustrates an example of portions of the system architecture shown in FIGS. 2A and 2B in accordance with aspects of the present disclosure.

FIG. 7 illustrates an example of portions of the system architecture shown in FIGS. 2A and 2B in accordance with aspects of the present disclosure.

FIG. 8 illustrates an example of portions of the system architecture shown in FIGS. 2A and 2B in accordance with aspects of the present disclosure.

FIG. 9 illustrates an example of portions of the system architecture shown in FIGS. 2A and 2B in accordance with aspects of the present disclosure.

FIG. 10 illustrates an example of portions of the system architecture shown in FIGS. 2A and 2B in accordance with aspects of the present disclosure.

FIG. 11 illustrates an example of portions of the system architecture shown in FIGS. 2A and 2B in accordance with aspects of the present disclosure.

FIG. 12 illustrates an example of portions of the system architecture shown in FIGS. 2A and 2B in accordance with aspects of the present disclosure.

FIG. 13 illustrates an example of portions of the system architecture shown in FIGS. 2A and 2B in accordance with aspects of the present disclosure.

FIG. 14 illustrates an example of portions of the system architecture shown in FIGS. 2A and 2B in accordance with aspects of the present disclosure.

FIGS. 15-20 show flowcharts illustrating methods that support venue experience determinations and other aspects of the present disclosure.

FIG. 21 shows a diagram of a system including a device that supports venue experience determinations and other aspects of the present disclosure.

### DETAILED DESCRIPTION

The systems and methods disclosed herein relate to, among other things, venue rating systems and matching consumers with venues that track the consumer's preferences for venue vibes and other criteria. The systems and methods disclosed herein relate to at least three major components, each of which provides a unique approach to one or more areas of functionality. A first component relates to the use of real-time video inputs, which allow consumers and businesses to analyze a venue in real-time and help measure and/or determine an experience or other criteria associated with that venue. The business and consumer interfaces associated with the systems and/or methods may include machine vision capabilities that aid in the searching and reviewing of video.

Another component relates to venue level experience metrics, which enable the business associated with the venue to describe an intended experience, vibe and/or other criteria associated with the venue. The venue level experience metrics may enable consumers to provide structured, non-linear feedback regarding the experience they had and/or are currently having at a venue. Data-mining and nearest-neighbor algorithms may be utilized to help businesses and consumers search more effectively and understand the discussions and descriptions around experience at a venue level.

A further component relates to product and/or service level experience metrics, which allow similar discussion as the venue level experience metrics, but typically on a smaller scale. For example, the product and/or service level experience metrics may include feedback about specific menu items, amenities, personnel, or other specific services or products available at the venue. Data-mining and nearest-neighbor algorithms may be utilized to help businesses and consumers search more effectively and understand the discussions and descriptions around product and/or service level experience metrics at a venue level.

These components may operate using the concept of “vibes” as a core tenant of data tagging and understanding relationships between various businesses, various consumers, and a business and its consumers. Vibes may be defined as a living taxonomy of positively oriented adjectives commonly used to describe experience from an emotional perspective. The systems and method disclosed herein may has a core set of vibes that are human crafted with definitions, examples, etc. and may be configured to continue to learn new vibes based on user feedback and activity. Some example vibes include lively, laid back, old-school, modern, and intimate.

Vibes are a unique way of describing experience or other criteria associated with a venue, product or service. Vibes are a set of potential tags which can be utilized to identify the experience a consumer will have at a venue. The unique combination of vibes for a venue, combined the with business type associated with the venue (i.e., restaurant, gym, bar, etc.), and cuisine/genre, provides an experience index for a venue. The set of vibes disclosed herein are unique to the disclosed systems and methods. The following list of vibes is exemplary only and is not exclusive of the vibes that can be used: Lively, Music, Home, Sports, Business, College, Laid-back, Low-Key, Nature, Quiet, Family Friendly, Kid Friendly, Dog Friendly, Wheelchair Accessible, Culture, Country, Disco, Hip-hop, R&B, Rock, Reggae, Health, Party, Carnival, Unique, Intimate, Classic, Speakeasy, Exclusive, Organic, Simple, Sophisticated, Familiar, Hip, Whimsical, Calm, Casual, Exotic, Patio, Serene, Gothic, Grand, Loud, Modern, Religious, Romantic, Artsy, Friendly, Spiritual, Tranquil, Cozy, Formal, Mellow, Sensible, silly, Vibrant, Old Fashion, Traditional, Yo-Pro, Dive, Energetic, Peaceful, Swanky, Upbeat, Happening, Indoor, Cheerful, Short Wait, Theatrical, Playful, Relaxed, Flirty, Youthful, Pet Friendly, and Cool. One aspect of the systems and method disclosed herein use of this set of descriptions or vibes as a labelling hierarchy for tagging data points in order to classify and relate data points, at venues such as restaurants, gyms, bars, stores, etc. or in association with offered goods or services.

Another aspect of the present disclosure relates to using vibe feedback to create recommendations. By analyzing how businesses rate their own crafted experience at a venue using a metric tag set (e.g., the system's vibe list), and how consumers rate their experiences relative to the same metric tag set, the systems and methods are able to identify patterns within user behavior and make customized recommendations for individual users and/or classes of user. For example, if a user A has tagged a set of venues similarly to a group of people B, and a new venue is introduced to that group B for tagging, the group's tags are a prediction of how the user A would likely tag the same new venue. The system may utilize a custom set of tags (e.g., vibes) to feed this algorithm. It is the use of vibes and the nature in which the nearest neighbor algorithm is tuned that may provide a unique value. Consumer feedback may be tagged with timestamps and venues based on geofencing feature of the mobile app on a customer's device. Geofencing and timestamp tracking may be used to limit feedback to venues the customer has actually visited, and to the time they visited it.

A further aspect of the present disclosure relates to using one or more video inputs from a venue to measure wait times at that venue. The systems and methods utilize cameras trained on wait areas to take direct measurement of wait times. Cameras track the amount of time people are in the wait area using machine vision techniques.

Another aspect of the present disclosure relates to determining bounce rates. The systems and methods introduce the concept of bounce rates to brick and mortar retail venues. Bounce rates are a metric traditionally used for measuring behavior on a website. The present systems and methods apply bounce rates to brick and mortar venues. As such, the definition of a retail bounce rate may be defined as an event wherein a potential customer physically entering a brick and mortar retail venue such as a restaurant, bar, gym or store, and then leaves the venue without engaging in meaningful interaction with the retail venue. Meaningful interaction may include, for example, shopping, browsing, speaking to a salesperson or employees, making a purchase, etc. The concept of a bounce rate in the context of a retail venue is new and unique to the system. A retail venue bounce event and/or bounce rate may be determined using various aspects of the present systems and methods.

In one example, video inputs may be used to assist with measuring bounce rates. The system uses video to analyze customer traffic at a venue and determine whether or not a customer visit constitutes a retail venue bounce, as described above.

A further aspect of the present disclosure relates to using one or more video inputs to measure demographics. The system will utilize video feeds to anonymously analyze the demographics of customers. Demographics will be collected in conjunction with other data tags such as camera venue and timestamp.

Another aspect relates to using video inputs to measure atmosphere of a venue. By combining video feeds and customer feedback, the system can learn what vibes apply to a venue. As customers provide feedback about the venue, including selection of vibes that describe the venue, that feedback will be combined with video taken at the same time the customer was on site to learn what the customer feedback “looks like.” In other words, if a customer visits a restaurant at 6:05 pm on a given date, the system will look at one or more video frames from the venue collected at that time and link those video frames to the customers feedback. In one example, the customer provided feedback that the restaurant was lively and casual at a particular time. The system will then learn what lively and casual looks like from the video received at that time. If the video input received for that venue in the future ever looks the same, the system can adjust the vibes associated with how the venue is labeled and/or marketed to include the vibes which customers provided the last time the venue “looked” that way.

Many other aspects and details associated with the present disclosure are described with reference to the figures as described below. Reference to customer may be used interchangeably with patron or other terms identifying a person or living being that provides input into, is observed by, or is otherwise engaged with or focused on using the system and methods disclosed herein.

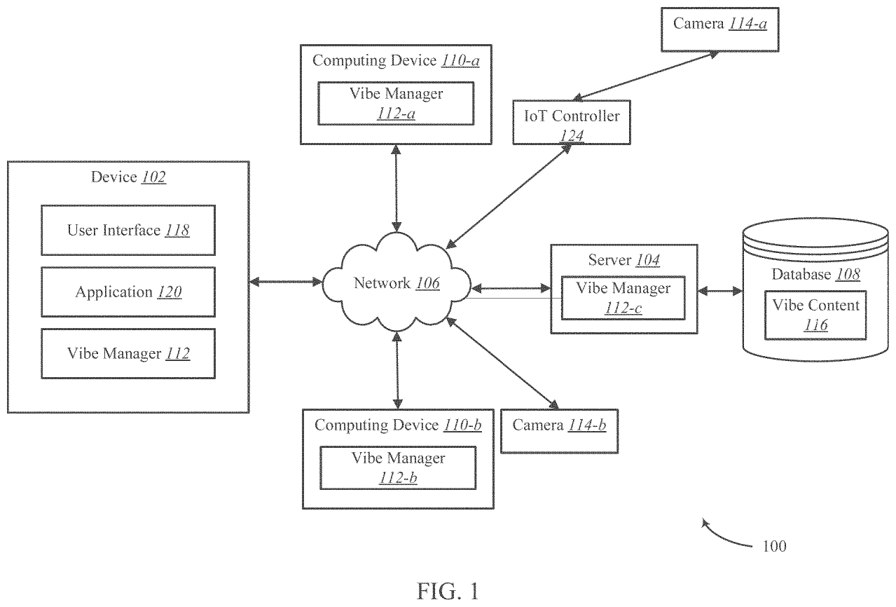

FIG. 1 illustrates a block diagram illustrating one example of a venue experience system 100 in which the present systems and methods may be implemented. In some examples, the systems and methods described herein may be performed on a device (e.g., device 102). As depicted, the venue experience system 100 may include a device 102, server 104, a network 106, and a computing device 110, and that allows the device 102, the server 104, and the computing device 110 to communicate with one another. The computing device 110 may be represented as two or more computing devices 110-a, 110-b.

Examples of the device 102 may include any combination of, for example, mobile devices, smart phones, personal computing devices, computers, laptops, desktops, servers, media content set top boxes, or any combination thereof.

Examples of computing device 110 may include at least one of one or more client machines, one or more mobile computing devices, one or more laptops, one or more desktops, one or more servers, one or more media set top boxes, or any combination thereof.

Examples of server 104 may include, for example, a data server, a cloud server, proxy server, mail server, web server, application server, database server, communications server, file server, home server, mobile server, name server, or any combination thereof.

Although computing device 110 is depicted as connecting to device 102 via network 106, in some examples, device 102 may connect directly to computing device 110. In some examples, device 102 may connect or attach to at least one of computing device 110 or server 104 via a wired or wireless connection, or both. In some examples, device 102 may attach to any combination of a port, socket, and slot of computing device 110 or server 104.

In some configurations, the device 102 may include a user interface 118, application 120, and vibe manager 112. Although the components of the device 102 are depicted as being internal to the device 102, it is understood that one or more of the components may be external to the device 102 and connect to device 102 through wired or wireless connections, or both. Examples of application 120 may include a web browser, a software application, a desktop application, a mobile application, etc. In some examples, application 120 may be installed on computing device 110 in order to allow a user to interface with a function of device 102, server 104, computing device 110, and vibe manager 112.

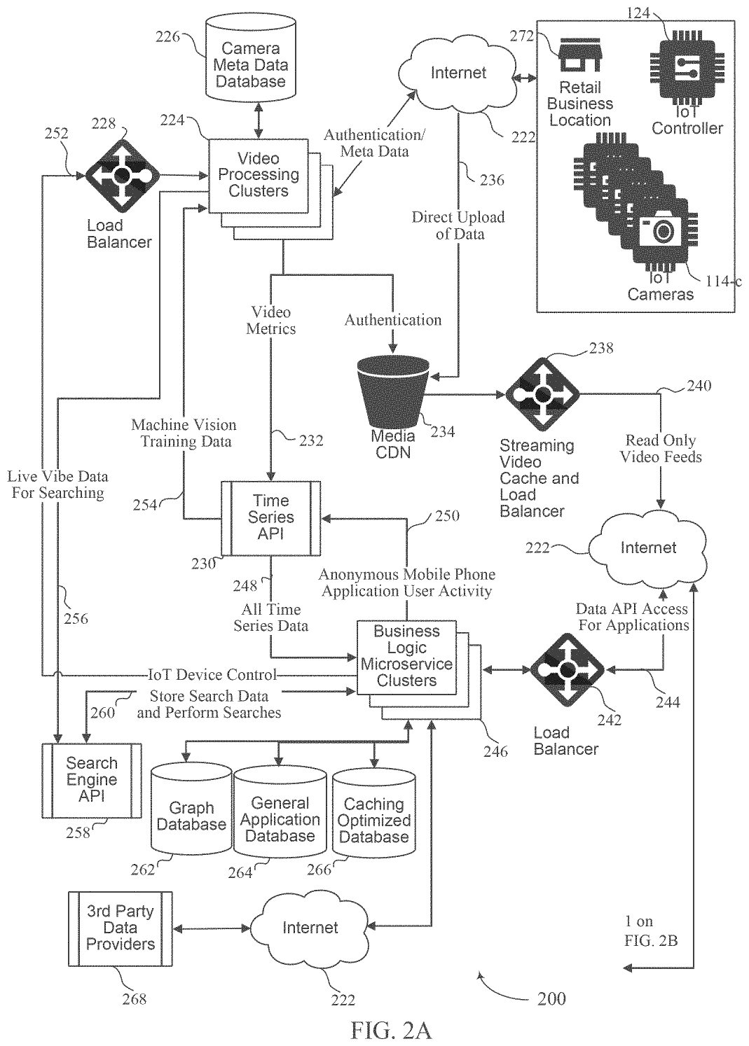

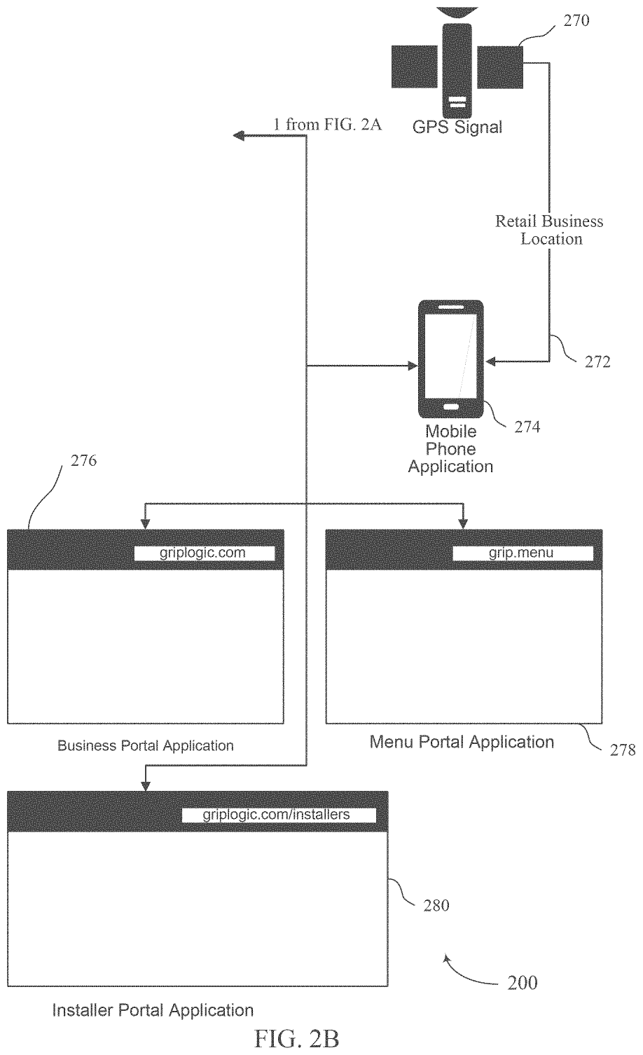

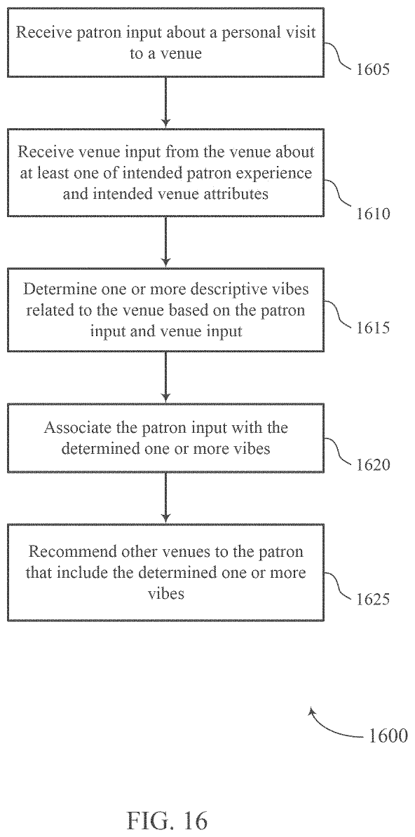

Although device 102 is illustrated with an exemplary single application 120, in some examples application 120 may represent two or more different applications installed on, running on, or associated with device 102. In some examples, application 120 may include one or more software widgets. In some cases, application 120 may include source code to operate one or more of the systems or system components described below with reference to FIGS. 2-15, or the method steps disclosed in FIGS. 16-21.

In some examples, device 102 may communicate with server 104 via network 106. Examples of network 106 may include any combination of cloud networks, local area networks (LAN), wide area networks (WAN), virtual private networks (VPN), wireless networks (using IEEE 802.11 (Wi-Fi), for example), cellular networks (using 3G, LTE, or 5G, for example), etc. In some configurations, the network 106 may include the Internet. In some examples, the device 102 may not include vibe manager 112. For example, device 102 may include application 120 that allows device 102 to interface with a separate device via vibe manager 112 being located on another device such as computing device 110 or server 104, or any combination thereof.

In some examples, at least one of device 102, computing device 110, and server 104 may include vibe manager 112 where at least a portion of the functions of vibe manager 112 are performed separately or concurrently on device 102, computing device 110, and/or server 104. In some examples, a user may access the functions of device 102 (directly or through device 102 via vibe manager 112) from computing device 110 or server 104. In some examples, computing device 110 includes a mobile application that interfaces with one or more functions of device 102, server 104, or vibe manager 112.

In some examples, server 104 may be coupled to database 108. Database 108 may be internal or external to the server 104. In one example, device 102 may be coupled to database 108. In some examples, database 108 may be internally or externally connected directly to device 102. Additionally, or alternatively, database 108 may be internally or externally connected directly to computing device 110 or one or more network devices such as a gateway, switch, router, intrusion detection system, etc. Database 108 may include vibe manager 112 or operate portions of vibe manager 1112. In some examples, device 102 may access or operate aspects of vibe manager 112 from database 108 over network 106 via server 104. Database 108 may include script code, hypertext markup language code, procedural computer programming code, compiled computer program code, object code, uncompiled computer program code, object-oriented program code, class-based programming code, cascading style sheets code, or any combination thereof.

In one example, device 102 may be coupled to database 108. In some examples, database 108 may be internally or externally connected directly to device 102. Additionally, or alternatively, database 108 may be internally or externally connected directly to computing device 110, camera 114, an IoT controller 124, or one or more network devices such as a gateway, switch, router, intrusion detection system, etc.

Vibe manager 112 may enable a variety of features and functionality related to a venue. In some examples, vibe manager 112 may be configured to perform the systems and methods described herein in conjunction with user interface 118 and application 120. User interface 118 may enable a user to interact with, control, or program one or more functions of vibe manager 112.

In some examples, vibe manager 112 enables determination of a consumer experience and/or aspects of an environment associated with a particular venue. In some examples, vibe manager 112 may receive real-time video from one or more IoT controllers 124 that receive video from one or more cameras 114 associated with one or more venues. In some examples, vibe manager may provide recommendations to a consumer for venues that match the consumer's desired vibe parameters. In some examples, the vibe manager 112 may provide machine learning related to visual indicators of vibes for one or more venues based at least in part on customer feedback about vibes during a particular visit to the one or more venues. The vibe manager 112 may determine a group of customers that have preferences for certain vibes based on at least one of customer feedback about vibes from a given venue, labeling of desired vibes or other descriptors provided by venue managers, and real-time video provided from the venue. Generally, in some cases, application vibe manager 112 may include or provide control of one or more of the systems or system components described below with reference to FIGS. 2-15, or the method steps disclosed in FIGS. 16-21.

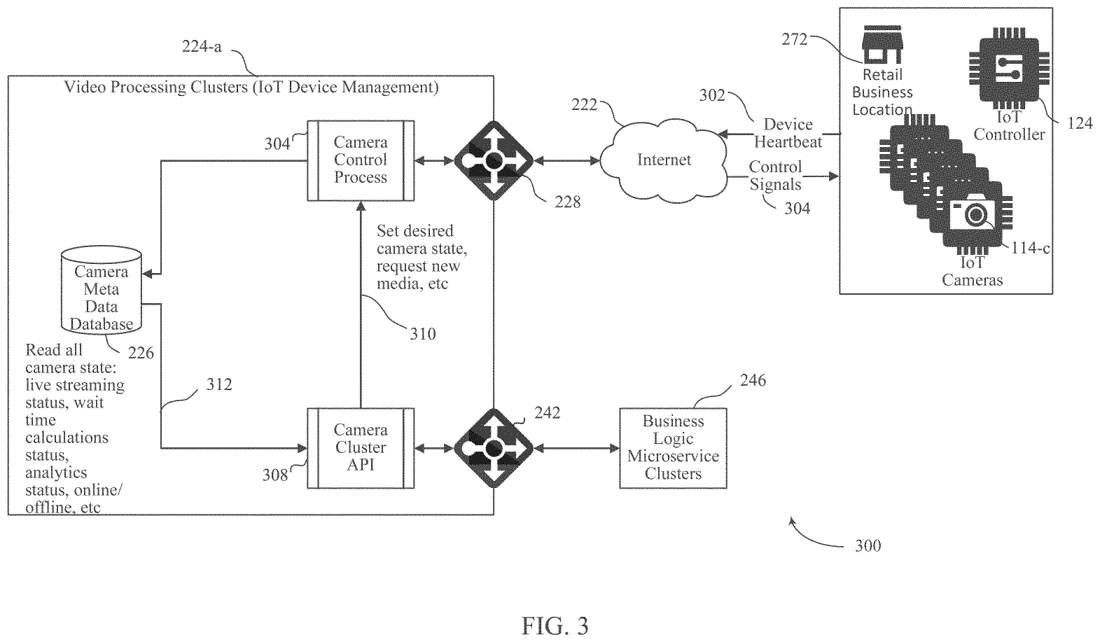

FIGS. 2A and 2B illustrate an example of a system architecture 200 that supports the vibe related functionality in accordance with aspects of the present disclosure. In some examples, system architecture 200 may implement aspects of venue experience system 100. In the illustrated example, system architecture 200 is an example of the underlying components and structure used to carry out one or more of the functions and/or methods disclosed herein. Further details regarding the components and structure shown in FIGS. 2A and 2B are explained below with reference to FIGS. 3-15.

As shown, system architecture 200 may include cameras 114-c, which may be examples of the cameras 114 shown in FIG. 1. The cameras 114-c may be located at a venue such as a retail business location 272. The cameras 114-c may communicate with IoT controllers 124 that communicate with video processing clusters 224 via a network such as internet 222. Internet 222 may be one example of the network 106 of FIG. 1. Data from the cameras 114-c may be saved in camera metadata database 226. Video metrics 232 may be communicated from the video processing clusters 224 to a time series API 230. Processed video feeds 236 may be communicated from the IoT controller 124 to a media CDN 234. The media CDN 234 may be in communication with streaming video cache and load balancer 238 which provides read-only video feeds 240 to the internet 222 or similar network.

A business logic microservice clusters 246 may receive all time series data 248 from the time series API 230 and provide anonymous mobile phone application user activity 250 back to the time series API 230. The business logic micro service clusters 246 may communicate with a separate load balancer 242, which is in communication via data API access for applications 244 with internet 222. Business logic microservice clusters 246 may provide IOT device control 252 to a load balancer 228, which is in communication with the video processing clusters 224. The business logic microservice clusters 246 may also be in communication with a search engine API 258, wherein stored search data and platform searches are communicated therebetween. The business logic microservice clusters 246 may also be in communication with a graph database 262, a general application database 264, and cache optimized database 266. Further, the business logic microservice clusters 246 may be in communication with a third-party data provider 268 via the internet 222.

The search engine API 258 may receive live vibe data for searching 256 from the video processing clusters 224. Further, the time series API 230 may provide machine vision training data 254 to the video processing clusters 224.

The system architecture 200 may include or provide communication with one or more mobile phone applications 274, which are in communication with the internet 222 and a GPS signal 270 via a retail business location 272.

The system architecture 200 may also include business portal application 276, menu portal application 278, and installer portal application 280, and/or provide access to such applications via the internet 222. Such applications 276, 278, 280 may be in communication with the mobile phone application 274 for mobile communication with and control of the system architecture 200 or aspects thereof.

FIG. 3 shows a system 300 that may be a portion of the system architecture 200 described above with reference to FIGS. 2A and 2B. The system 300 includes the cameras 114-c, which may include, for example, IoT cameras and IoT controllers. The IoT controller 124 may be located at a venue such as a retail business location 272. The IoT controller 124 communicates information to a video processing cluster 224-a via, for example, the internet 222 and a load balancer 228. The IoT controller 124 may communicate a device heartbeat 302 and receive control signals 304 (also referred to a camera control process 304).

The load balancer 228 may act as a gate or inlet to the video processing clusters 224. A separate load balancer 242 may act as an outlet or separate inlet for communication between the video processing clusters 224-a and business logic microservice clusters 246.

The IoT controller 124 may include camera control process 304, camera cluster API 308, and the camera metadata database 226. The IoT controller 124 may provide reading of camera state, such as live streaming status, wait time calculations status, analytics status, online/offline, etc. 312, which may be communicated between the camera metadata database 226 and the camera cluster API 308. The IoT controller 124 may also set desired camera state and request new media, etc. 310, which may be provided from the camera cluster API 308 to the camera control process 304. The camera control process 304 may be in communication with the load balancer 228. The camera cluster API 308 may be in communication with the load balancer 242. The video processing cluster 224-a may receive and store the aggregate data generated by the IoT controller 124.

For the purposes of processing video and images, the term “media” may refer to both images and video individually and/or collectively. An image may be processed as, for example, a single frame video segment.

The system 300 may provide one or more camera control points for cameras to register and to consume video and image data from cameras. The system 300 may also provide a control plane for servicing cameras. The data hierarchy associated with system 300 may include a camera 114-c, time series, and camera metadata, such as data stored in the camera metadata database 226.

A camera 114-c may provide or include, for example, a serial number, raw and/or blurred face video, raw and/or blurred face images. The time series may include a grouping by camera serial number. The time series may provide camera activity such as live streaming, collecting analytics, collecting wait times, and vibes. The time series grouped by camera serial number may also provide for patron activity and/or other patron data such as age, gender, and traffic.

The camera metadata may include, for example, serial number and status. The status may include online/offline, indicating that the camera is powered on and has internet connectivity. The status may include live streaming, collecting analytics, collecting wait times, current vibes, and the like. The status may also include the make, model, etc. of the one or more cameras.

The cameras may be provisioned using standard IoT camera protocols. The cameras may be registered against the camera control cluster and/or secured public endpoint. Once a camera registers its serial number status, it may be continuously updated in the camera metadata database 226. By default, a camera may have live streaming, analytics collection, and/or wait times disabled. Cameras may be assigned to accounts by an administrator by linking the camera serial number and installation address. Once cameras are assigned to an account in the metadata database 226, the authorized users within the account may assign the camera to a venue and determine what features to enable/disable, such as live streaming, analytics, wait times, etc.

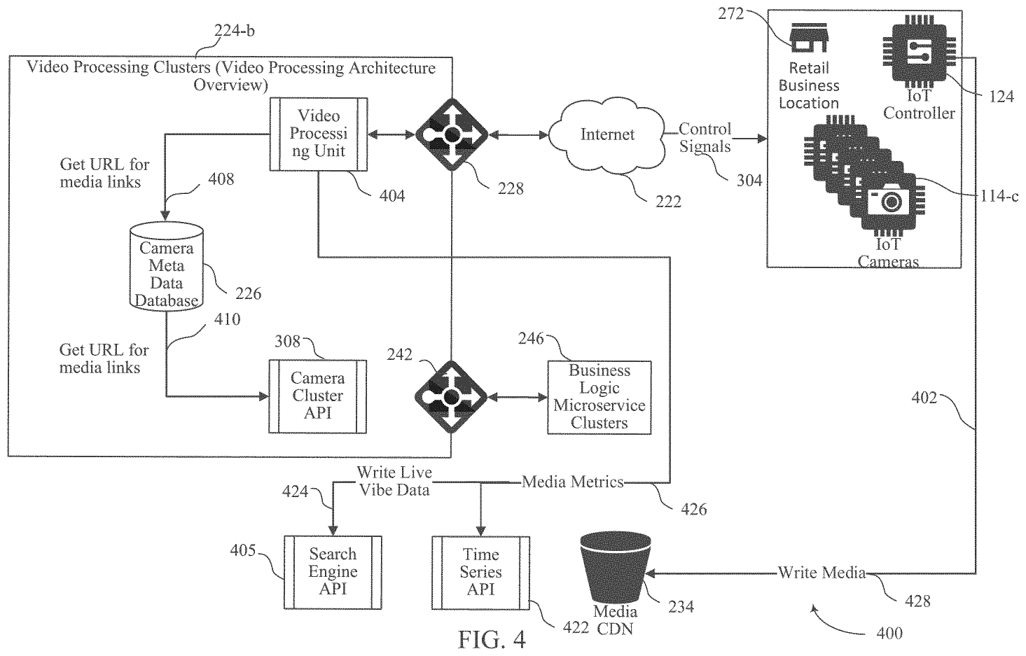

Referring to FIG. 4, a system 400 is shown, and the system 400 may represent a portion of the system architecture 200 shown in FIGS. 2A and 2B. System 400 may include the plurality of cameras 114-c in communication with the IoT controller 124 which may be in communication with the video processing clusters 224-b. The cameras 114-c may be located at a venue such as a retail business location 272. The IoT controller 124 may communicate media 402 via, for example, the internet 222 to the video processing clusters 224-b. The IoT controller 124 may receive control signals 304 from the video processing clusters 224-b or other source via, for example, the internet 222. Load balancers 228, 242 may provide an interface with the load processing clusters 224-b. The IoT controller 124 may include video processing unit 404, camera metadata database 226, and camera cluster API 308. The URL for media links 408 may be communicated from the video processing unit 404 to the camera metadata database 226. The URL for video links 410 may be communicated from the camera metadata database 226 to the camera cluster API 308 via the video processing clusters 224-b. The video processing unit 404 may be in communication with a search engine API 420, time series API 422, and a media CDN 234. Write live vibe data 424 may be transferred from the video processing unit 404 to the search engine API 420. Media metrics 426 may be communicated from the video processing unit 404 to the time series API 422. Write media 428 may be communicated from the video processing unit 404 to the media CDN 234. The video processing clusters 224-b may be in communication with business logic microservice clusters 246 via the load balancer 242.

Live streaming cameras 114-c may store short (e.g., about 1 to 60 seconds, and typically about 15 seconds) video clips in mobile optimized formation within the video store of the system 400. This video may include blurred faces for customers shown in the video. This video may be available for consumption by a mobile application. If a camera remains online, the short clips may be generated on a variable frequency (e.g., about every 5 to 15 minutes), as configured by the business or venue.

Data processing may include collecting single images on a variable frequency (e.g., about once every 30 seconds to 5 minutes, and typically about every minute) and analyze the image to collect metrics about activity viewed on the camera. Such activity may include, for example, a number of cases, age of faces, gender of faces, and vibes.

The camera cluster 114-c may combine mobile app user feedback data with images to create machine vision models that will visually identify the vibes in an image. Such identification of vibes in the image may be used to create a real-time tuning of a venue's vibes relative to the business' intended vibes. A venue may change its vibes throughout the day, week, or year. Machine vision may enable users of the mobile app to search for venues based on vibes that are actually present at that moment. The camera cluster 114-c may update these models on a variable frequency, which may be adaptive, based on how often the trained machine vision neuro networks produce different results relative to training data.

The machine vision training system may be modified in an ongoing manner. This may apply both to the rate of change in neuro networks produced by the training, as well as the methods by which the networks are trained. Hyper parameters and manual machine tuning, as well as other possible tuning methods, may be applied and modified over time. This may include changing layers, convolution networks, assemblies, etc.

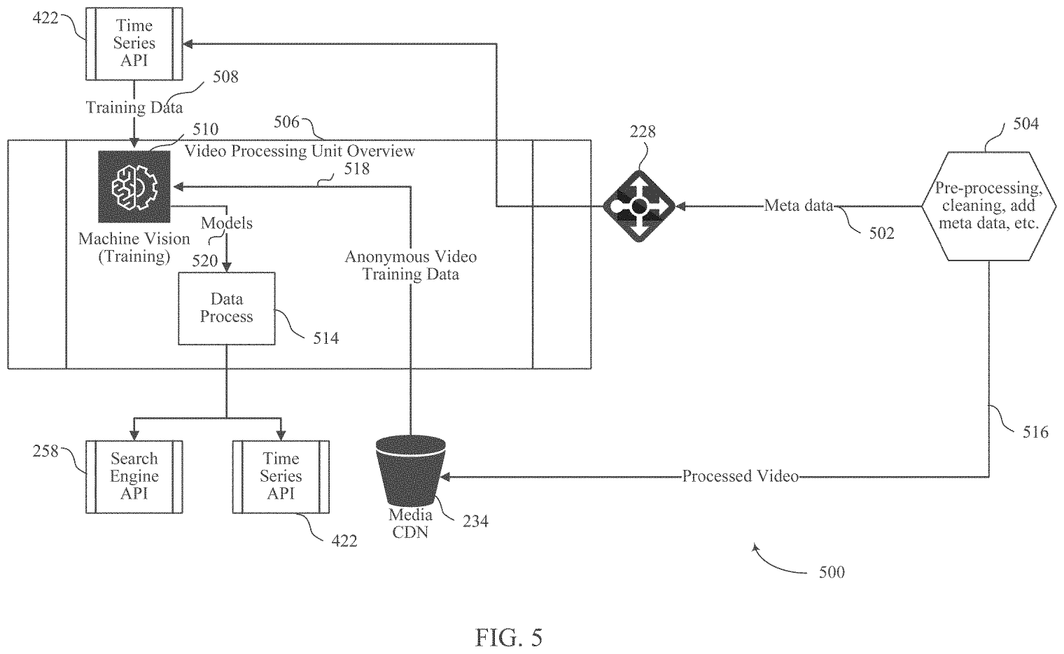

A machine vision unit, as will be described with reference to FIG. 5, may combine mobile app user feedback with historical, anonymous media to create models for predicting user feedback. The models may operate to learn how to visually identify vibes and other user/customer measurable metrics in the live media streams. Machine vision units may be used with trained models to process media in real-time to identify vibes and other user/customer measurable metrics in the live media streams. Such metrics may be stored in the search engine API. Once stored in the search engine API, live media streams may become searchable, including searching via the mobile app users.

Referring now to FIG. 5, an example system 500 is shown. The system 500 may be one aspect of the system architecture 200 shown in FIGS. 2A and 2B. The system 500 may include a video processing unit overview 506 that receives video and images 502 via one or more load balancers 228. The video processing unit overview 506 may also receive training data 508 via time series API 422.

The video processing unit overview 506 may include machine vision (training) 510, a data process 514, live stream process 516, and pre-processing, cleaning and metadata, etc. 504. The machine vision 510 receives the training data 508 from the time series API 422 and receives training data 518 from the media CDN 234. The pre-processing, cleaning, add metadata, etc. 504 receives the video and images 502, and is in communication with the data process 514 and live stream process 516. The live stream process 516 is in communication with the media CDN 234. The data process 514 is in communication with the search engine API 258 and the time series API 422.

The video processing unit may be responsible for accepting all inbound media. The main functions of the video processing unit may be broken into four major areas: preprocessing, live stream process, data process, and machine vision. The preprocessing may include performing universal processing on media. The preprocessing may include preparing media content for consumption by other parts of the video processing unit. The live stream process may include performing work needed to produce live media for the mobile app. The live stream process may include producing training videos for the machine vision component. The data process may include performing work needed to extract metrics from one or more media feeds. The data process may include performing work needed to extract live vibe data from one or more media feeds. The machine vision may include accepting training data to build models for extracting information from visual medial data. The machine vision may include exporting models for use in other components for extracting information from visual media data.

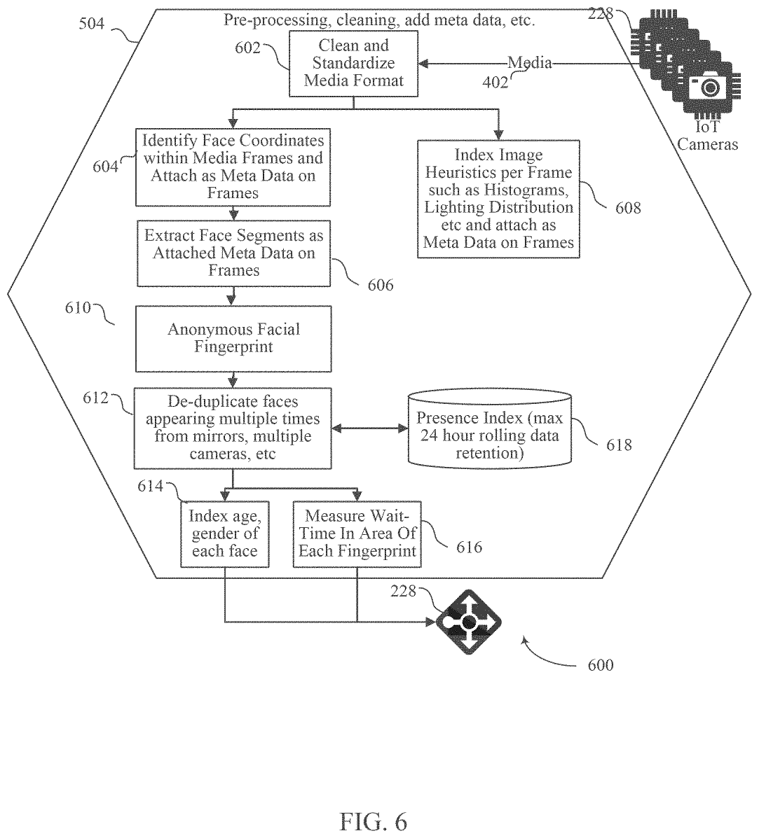

FIG. 6 shows a system 600 which may be a part of the system architecture 200 shown with reference to FIGS. 2A and 2B and/or the part of the systems 300-500 shown with reference to FIGS. 3-5. System 600 includes a preprocessing, cleaning, add metadata, etc. 504 that is in communication and/or receives media 402 from one or more load balancers 228. The preprocessing, cleaning, add metadata, etc. 504 includes components and/or functionality such as, cleaning and standardized media format 602, identify face coordinates within media frames and attach as media data on frames 604, extract face segments as attached metadata on frame 606, anonymous facial fingerprint 610, D-duplicate faces appearing multiple times for mirrors, multiple cameras, etc. 612, index age, gender of each face 614, and measure wait time in area of each fingerprint 616. The steps 614, 616 may be in communication with the load balancer 228. The step 616 may be in communication with a presence index 618. The presence index 618 may include, for example, maximum 24-hour rolling data retention. index image heuristics per frame such as histograms, lifting distribution, etc. and attach as metadata on frames 608. The preprocessing, cleaning, add metadata, etc. 504 may have an output 610 in communication with the functions 606, 608, and/or 604.

The system 600 may include, for example, standardizing media including, for example, ensuring correct format (e.g., MPG, PNG, etc.), ensuring correct size (e.g., resolution requirements), histogram formalization, and other standardizations that may be needed at some point during operation. The system 600 may provide face identifying coordinates including, for example, locating the human faces in each frame of the media. This identifying coordinates may include data that is attached as metadata to the media stream 402. Extracting face segments may include, for example, extracting each face from the parent image frame as a cropped image around the face. Each face may be extracted from the parent image frame as a cropped image around the face. This data may be attached as metadata to the media stream 402.

The system 600 may provide index imaging including, for example, general properties of the image being indexed. Such properties may change over time, and may include, for example, histograms, lighting distribution, and other frequency patterns.

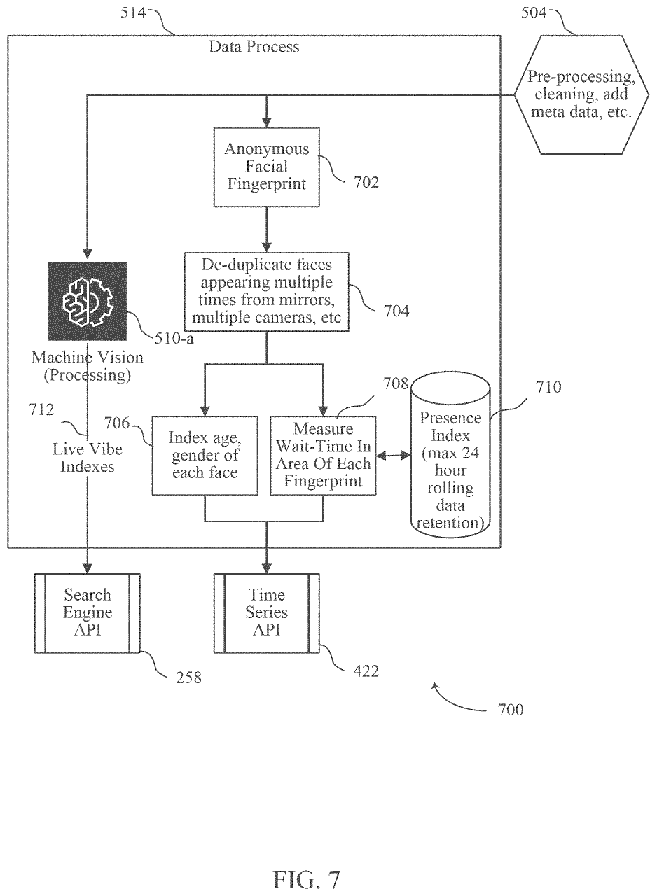

FIG. 7 shows a system 700 that may be one example of a component or portion of the system architecture 200 shown in FIGS. 2A and 2B, or other of the systems 300-600 shown in FIGS. 3-6. The system 700 includes a data process 514 in communication with preprocessing, cleaning, add metadata, etc. 504. Data process 514 includes machine vision (processing) 510-a, anonymous facial fingerprint 702, D-duplicate faces appearing multiple times for mirrors, multiple cameras, etc. 704, index age, gender of each face 706, measure wait time in area of each fingerprint 708. The steps 706, 708 may be in communication with the time series API 422. The machine vision 510-a may provide live vibe indexes 712 to the search engine API 258. The step 708 may be in communication with a presence index 710. The presence index 710 may include, for example, maximum 24-hour rolling data retention.

The system 700 may provide for extraction of information from media streams. The machine vision may provide extracting live vibes. The vibes may be labels for an experience in an environment such as a venue. Live vibes may be the vibes that are visually apparent in a live media stream in real-time. The live vibes may be sent to the search engine in real-time in order to enhance search results by enabling modification of baseline, human identified vibes, etc. with the live data.

Anonymous facial fingerprint may include, for example, each human face having unique characteristics that allow indexing of a basic structure. The index may be treated like a fingerprint, uniquely identifying each face. The unique facial tracking may be required to estimate wait times. Counting total faces describes a load on a facility (or the users/capacity). This load does not immediately identify how long any particular user has waited in the area. Understanding how long each unique face is present may indicate the throughput, and thus the actual wait time through direct measurement.

The duplicate faces may include, for example, examining fingerprint data to find the same faces appearing multiple times. This may occur due to, for example, tv screens, mirrors, selfies, etc.

Indexing age and/or gender may include, for example, using algorithms to identify information about each unique face. The data may be converted through time series format.

Measuring wait time may include, for example, each facial fingerprint index being stored in a database. A database may be track when a face appears on a specific camera. A heuristic is used to determine when a face has arrived on camera, as opposed to just passing through the frame. This may be learned over time. A heuristic may be used to determine when a face is no longer within a camera view, as opposed to just briefly losing site of that face. A dynamic algorithm may be used to combine the wait times of individual faces into a single estimated wait time. Examples of potential algorithms/methods may include, for example, arithmetic mean, 90th percentile, or the like.

A presence index may include, for example, a database with stored fingerprints for a maximum period of time such as, for example, 24 hours. Each fingerprint may be aged out within that set period of time (e.g., 24 hours) of the fingerprints appearing. This database may be used to ensure that wait times are tracked over time, and to ensure that the same individuals are not tracked between visits to a given venue.

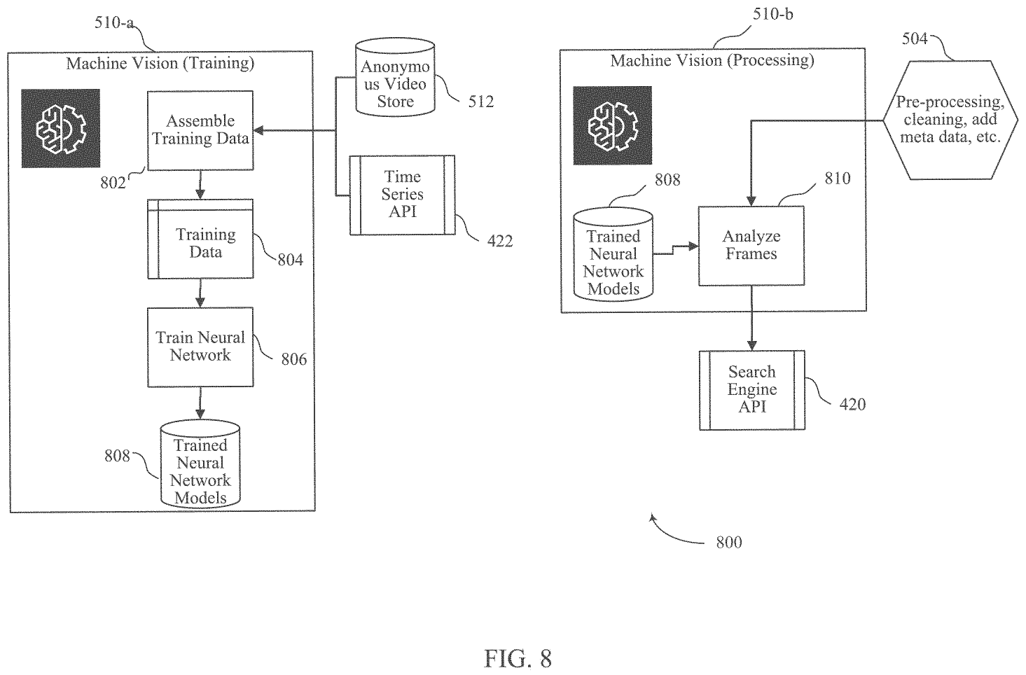

FIG. 8 illustrates an example system 800 that may represent one or more portions or components of the system architecture 200 shown in FIGS. 2A and 2B or any of the systems 300-800 described with reference to FIGS. 3-7. The system 800 may include a machine vision (training) 510-a that may be one example of the machine vision 510 described above. A machine vision 510-a may be in communication with an anonymous video store 512 and a time series API 422. The machine vision 510-a may include symbol training data 802, training data 804, training neuro network 806, and trained neuro network modules 808.

A machine vision (processing) 510-b may be one example of the machine vision 510 described above. The machine vision 510 may be in communication with a preprocessing, cleaning, add metadata, etc. 504 and a search engine API 420. The machine vision 510-b may include analyzing frames 810 and a trained neuro network module 808.

Machine vision system may be used to process historical media to create models that can be used to extract data from future media. The system 800 may use feedback data combined with the historical data to train the modules. The feedback data may come from a time series API 422. In future systems, other systems may be utilized. One aspect relates to the media from cameras being combined with human provided classifications (e.g., from time series data or any future source), in order to create training data. The training data may then be used to train modules. The modules may be used to identify vibes in received media. The models may be adapted and modified over time to look for different patterns in the data as business demands dictate and evolve.

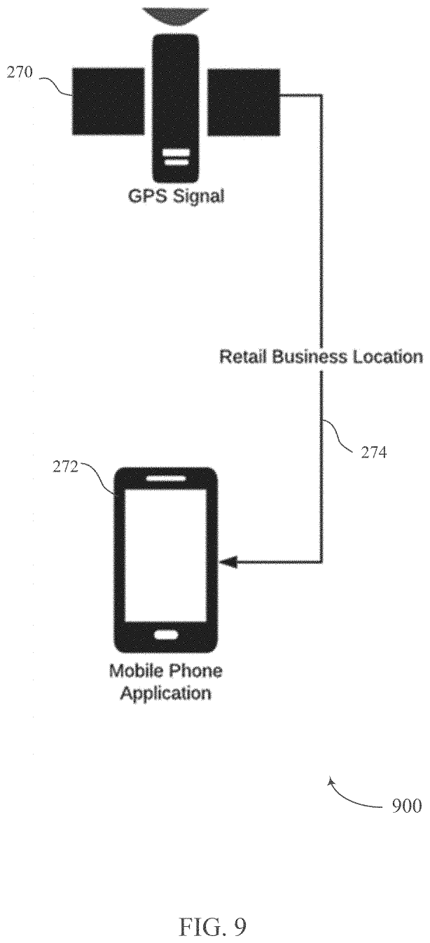

FIG. 9 shows a system 900 that may be one component of the system architecture 200 shown in FIGS. 2A and 2B or any of the systems 300-900 shown in FIGS. 3-8. The system 900 may include a GPS signal 270 that provides a connection related to a retail business location 272 with a mobile phone application 274.

The system 900 may provide venue search, also referred to as business retail location search (e.g., optimized by artificial intelligence), obtain basic business retail location information (e.g., contact information, website, hours of operation, waiting times, etc.), obtain real-time waiting times, recommendations (e.g., on business retail locations and specific products/services at the location/venue), ability to provide feedback to businesses, see live video and pictures from a business retail location (venue), receive GPS driven notifications on available menus at the venues, and other information based on user current location.

An example data hierarchy related to the system 900 includes searching a user profile. The searching may include results such as location, name, address, phone number, email, web address, hours of operation, menu, and vibes. The menu may include a category such as, for example, name, picture, and items, and such items may include name, description, nutrition, price, picture, etc.

The user profile may include, for example, the name, email, phone number, and feedback. The feedback may include a location and other information such as like/dislike, vibes, free text responses, and a menu. The menu may include, for example, items and like/dislike, free text response, etc.

Various use cases may include, for example, users searching for venue such as restaurants, bars, gyms, and other venues. Searching may have various filters such as, for example, name, address, phone, type (e.g., restaurant, bar, gym, etc.), vibes and location. Search results may be sorted by, for example, recommended (e.g., based on artificial intelligence (AI) and graph similarity between users), distance, and price. Users may view details for a given menu including, for example, name, address, phone, media (e.g., pictures and video), menu, hours of operation, and wait times. The menu may include, for example, categories, items and item details. The user may directly open any of the information on a listing for a given venue and where applicable, open data in external apps for use. Such information may include, for example, address, phone, email, and URLs. The address may include default map/navigation apps, Lyft, Uber, or other app links. The phone may include a dialer. An email may include emailing a client or their link. URLs may include mobile browsers.

A user may like/dislike venues. Such likes/dislikes may create an association between users, identifying which users like/dislike the same venues. Such likes/dislikes may in some instances not create an empirical rating of a particular venue. The user may also be prompted to check off any vibes they experience while at a particular venue. The user may be able to provide a free text feedback for any additional information they would like to add.

A user may like/dislike items on a menu. These likes/dislikes may create an association between users, identifying which users like/dislike the same menu items. Such likes/dislikes typically do not create an empirical rating of an item. The user may be able to provide free text feedback for any additional information they would like to add.

Users may be able to enable location services. For example, auto menu detection may be included. When a user enters a location, the application may notify the user that a digital menu is available for their current location. When the user has multiple venues in close proximity (e.g., such as in a food court building with multiple venues arranged vertically), multiple venues may be presented in order of most to least probability of the user's presence, and the user will select the venue where they are located. User enabled location services may also include venue services that unlock the ability to share location and menu item feedback. When location services are off, a user may only like/dislike a venue or menu item for building their own profile. When location services are on and the user has physically been at a venue within a certain time period (e.g., the past 48 hours), as identified by location history, the user may have the ability to add vibe and free text input to their feedback for a venue or the item.

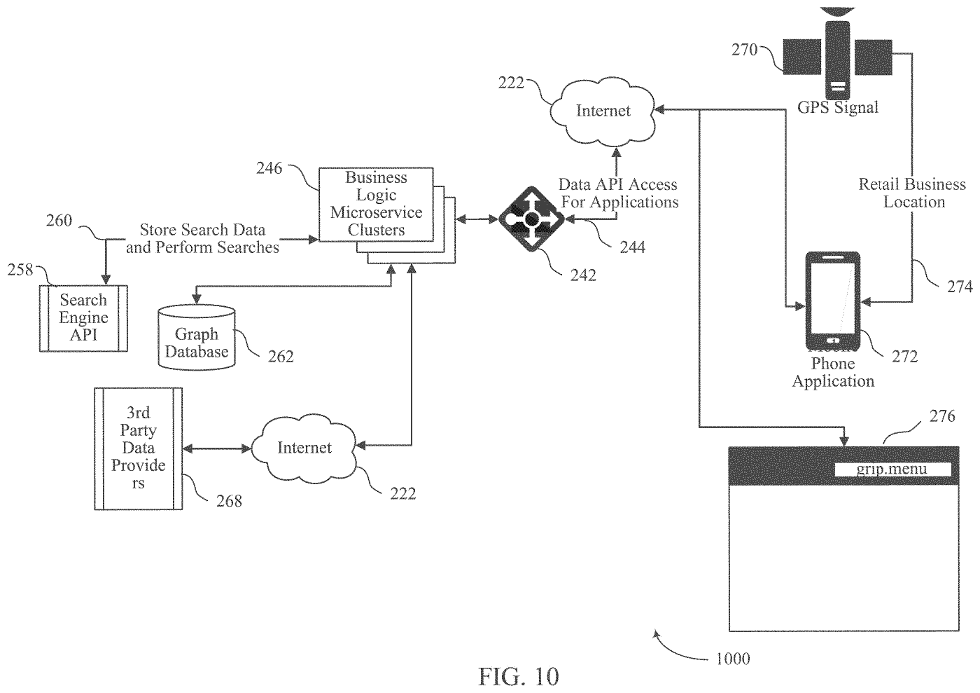

FIG. 10 illustrates a system 1000 that may represent one or more components or aspects of the system architecture 200 shown in FIGS. 2A and 2B, or other of the systems 300-1000 shown in FIGS. 3-9. The system 1000 includes GPS signal 270, retail business location 272, mobile phone application 274, and menu portal application 276, which may communicate with remaining portions of the system 1000 via internet 222 or other network. The API access for applications 244 may be communicated between the internet and one or more of the load balancers 242. The load balancer 242 is in communication with business logic microservice clusters 246. The business logic microservice clusters 246 communicate, store, search data, and perform searches 260 via the search engine API 258. Graph database 262 and a third-party data provider 208 are in communication with the business logic microservice clusters 246 such as, for example, via internet 222.

Providers of a mobile phone application and browser may provide the ability to search for venues. Search inputs may include, for example, location of device and GPS coordinates, sorting, flags, filters and the like. Sorting may include, for example, sorting by closest physical proximity, by recommendations for the customer, by lowest price, highest price, or shortest wait time. Flags may include, for example, trying something new, which may have an impact on recommendations. A filter may include, for example, filtering by location, vibes, what is currently open, live streaming access, name, address, or phone number. Location filtering may include GPS coordinate and/or range. GPS coordinate rectangular box, or governmental area (e.g., city, state, province, etc.) and range. Vibes may include, for example, experience, cuisine, type of venue, etc.

Various use cases related to system 1000 may include the user provider filter criteria and receiving results back matching their criteria. If there are few exact matches, additional and/or similar results also may be included. A user may provide short criteria and receive results back in desired order. Users may search without any location service access on their device by telling the app where they would like to search. Users may override location services on their device and pick other locations to search even if the device is allowing location service access to the app.

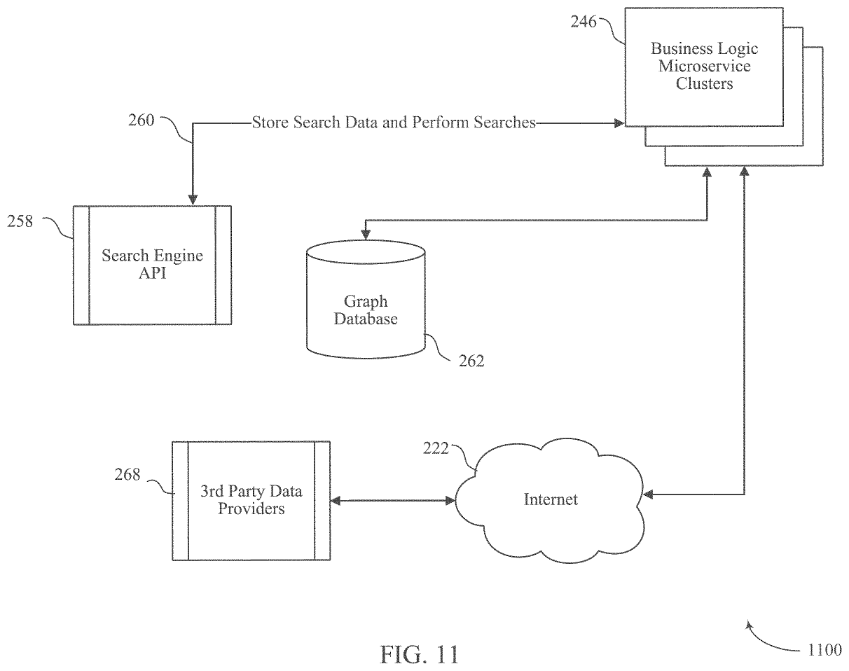

FIG. 11 shows a system 1100 that may represent one or more components of the system architecture 200 shown in FIGS. 2A and 2B, or any of the systems 300-1100 described with reference to FIGS. 3-10. The system 1100 may include business logic microservice clusters 246 that communicate with search engine API 258, graph database 262, and a third-party data provide 268 via, for example, the internet 222. Stored search data and performing searches 260 may be provided between the business logic microservice clusters 246 and the search engine API 258.

Search systems may use a combination of graph data and a search optimized storage system to combine user search criteria, user preference similarity, and venue information to identify, for example, a strongest suggestion for a user search. A graph database may permit comparison of a user's likes/dislikes and vibe feedback history, to see if a particular customer may have similar opinions. If multiple users have similar opinions on the same venue, there exists a probabilistic similarity between the venues for which only a subset of the users have shared feedback. Search results may be further enriched using third party data providers, which may do any one of the following or more: normalize addresses, provide media (e.g., images or video), provide contact information, and/or provide reservation services.

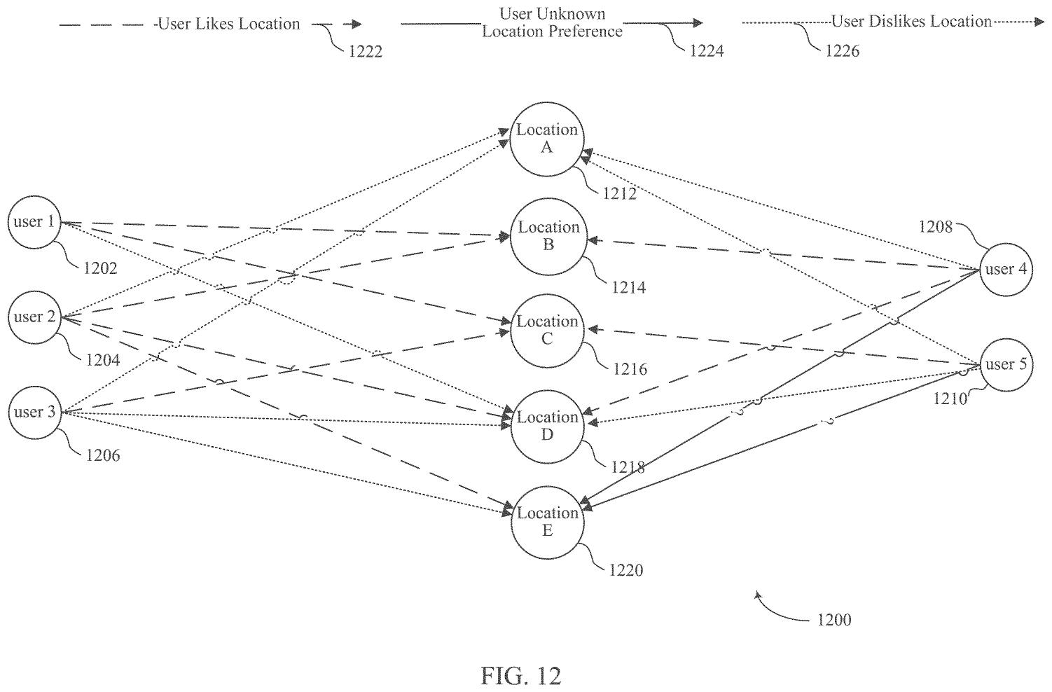

FIG. 12 shows the system and/or graphic 1200 that may be a component of, or the function or outcome related to the system architecture 200 or its operation or be associated with any of the systems 300-1200 described with reference to FIGS. 3-11. The system 300 includes a plurality of users 1202, 1204, 1206, 1208, 1210, and a plurality of locations A-E labeled as 1212, 1214, 1216, 1218, 1220. In one example, user likes location 1222 is provided. User unknown location preferences 1224 may be provided. User dislikes locations 1226 may be provided. FIG. 12 shows a relatively simple example of how recommendations may work. In the example shown in FIG. 12, there are five users and five locations. All users have liked or disliked some number of locations. Users 4 and 5 represented as 1208 and 1210 are asked about location 1220, and neither user has ever provided feedback on location 1220. Based on similarity, the system may determine that user 1208 seems most similar to user 1204 in terms of history of likes/dislikes. Thus, for user 1208 the system may predict that that user will like location 1220 because user 1204 already liked location 1220. Based on similarity, the system may determine that user 1210 is most similar to user 1206 because user 1206 has liked/disliked locations similarly to user 1210. Thus, the system may predict that user 1210 will dislike location 1220 because user 1206 already disliked location 1220.

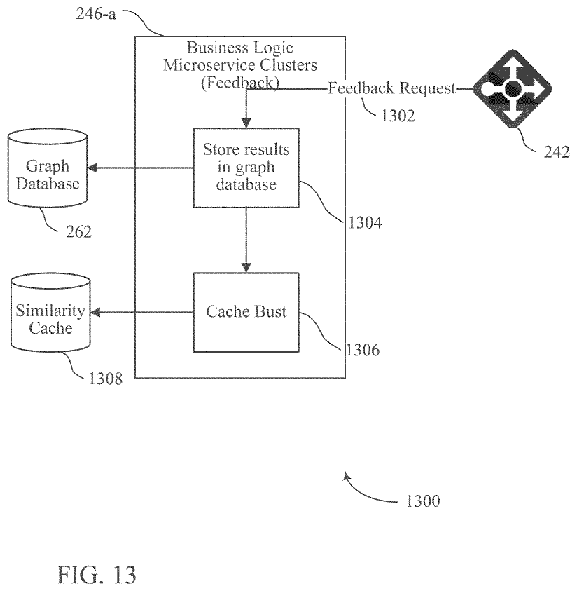

Referring to FIG. 13 an example system 1300 is shown and may represent one or more components of the system architecture 200 shown and described with reference to FIGS. 2A and 2B, or any of the systems 300-1300 described with reference to FIGS. 3-12.

System 1300 includes a business logic microservice clusters (feedback) 246-a in communication with a load balancer 242, a graph database 262, and a similarity cache 1308. The business logic microservice clusters 246-a may include storing results in graph database 1304 and cache bust 1306. The store results in graph database 1304 may be in direct communication with the graph database 262. The cache bust 1306 may be in direct communication with the similarity cache 1308.

Feedback may be recorded directly to the graph database 262. The similarity cache 1308 may be cleared for the user that provided data. The similarity cache 1308 may be used to optimize the search request process described below.

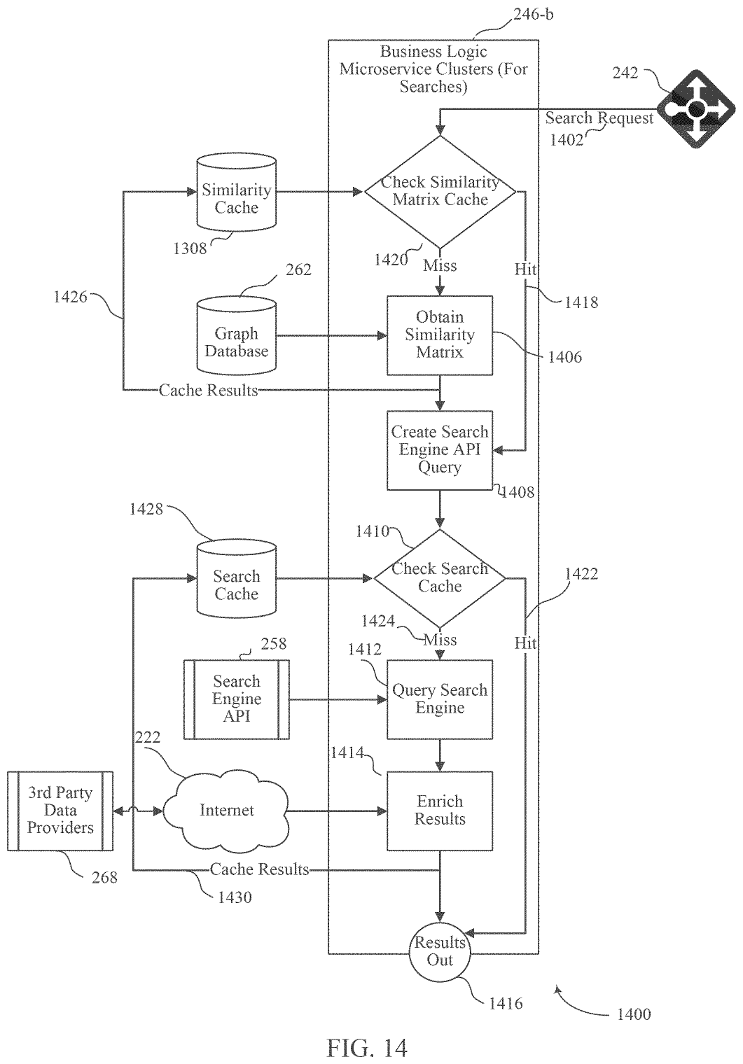

FIG. 14 shows a system 1400 that may represent one or more components of the system architecture 200 shown in FIGS. 2A and 2B and/or any of the system 300-1400 described with reference to FIGS. 3-13. The system 1400 includes a business logic microservice clusters (for searches) 246-b but is in communication with a load balancer 242. The load balancer 242 provides a search request 1402 that is directed to a check similarity matrix cache 1404. If there is a miss 1420, a obtain similarity matrix 1406 is used, followed by creating search engine API query 1408. If there is a hit 1418, the check similarity matrix cache 1404 directs directly to the create search engine API query 1408. The obtain similarity matrix 1406 receives information from graph database 262. Cache results 1426 are directed to a similarity cache 1408, which provides information to the checks similarity matrix cache 1404.

Following the create search engine API query 1408, a check search cache 1410 is provided. If a miss 1424 occurs, the system directs to a query search engine 1412 followed by an enrich results 1414. If a hit 1422 occurs, the check search cache 1410 is directed to a results out 1416. Cache results 1430 are directed to a search cache 1428, which is in communication with the check search cache 1410. A search engine API 258 provides information to query search engine 1412. A third-party data provider 268 may communicate with the enriched results 1414 via, for example, internet 222.

Search requests may include this, or other processes as shown in system 1400. The system 1400 may provide caches built in as the processing is prepared for a search. The caching may be broken into two or more stages. Multiple stages may allow tuning of the cache needs per stage. A similarity matrix may not be changed often. For each user, the similarity matrix typically will not be changed unless, for example, the user likes/dislikes something, thus triggering a cache bust. If the users most similar to a given user likes/dislikes something, this does not trigger a cache bust. The similarity matrix may provide for the duration of a cache length to vary heuristically but will not be on the order of magnitude of longer periods of time such as days.

Search results may not be likely to change often. The criteria is typically relatively specific. The duration of cache length typically varies heuristically but is not on the order of magnitude of shorter periods of time such as hours.

Cache evictions may occur under a number of circumstances including, for example, time out, out of space, maximum key cardinality, least recently used, and least often used.

A similarity matrix may extract the like/dislike matrix of similar users. A waiting of likes/dislikes of similar users may be weighted by a degree of similarity between the searching user and the related users. A user's own likes/dislikes may be part of the similarity matrix and have a maximum possible wait as these likes/dislikes are a match for him/herself. This ensures that a user's dislikes never appear in results and their favorite results always appear. Trying something new flag may include the user selecting “try something new” on their search, thereby the similarity matrix may be calculated slightly differently. The user's likes may be applied differently in order to omit them from results. This may allow the likes to influence recommendations, but the specific things the user liked will be omitted from results, thus allowing other results to fill in.

When crafting a search engine query, similarity data may be used to tune the search engine results score. Depending on the specific matrix, different results may have different scores/weights for the specific user. Once the search engine results are returned, the results may be enriched if needed with third party data.

Referring again to FIGS. 2 and 10, the menu portal application 278 relates to providing consumers with an alternative to installing the mobile application for accessing a digital menu directly in their mobile browser. Data hierarchy in this situation may include results of venue including, for example, name, address, menu, wherein the menu includes category by name, picture, items. The items may include name, description, nutrition, price, picture, etc.

Use cases related to the menu portal application 278 may include a consumer attempting to see a digital menu for a restaurant but does not want to install the mobile application. In this situation they can use the menu portal to access digital menus in their current venue. A browser-based application may be accessed by going to a particular URL, or by scanning a QR code available in print form on stickers or other media in the location/venue. Both methods may open the desired URL. If the user does have the mobile application installed, the application may be opened instead of the browser to show menu information. If the user does not have the mobile application installed, the user may see a website with available menus. The browser may prompt the user for location access (e.g., GPS). Once GPS is enabled, the site may show the menu of the user's currently location. If accuracy prevents identifying a single venue, multiple venues may be listed, and the user may be prompted to select from that list of venues. The site may have links to the app store for their advice, showing them how they can install the mobile app. Alternatively, the user can experience a full read-only version of the menu in their browser.

Referring again to FIGS. 2A and 2B, the business portal application 276 is described in further detail. The business portal application 276 may relate to, for example, providing access for businesses related to a particular venue to control and/or access data related to their retail locations (e.g., venues such as a restaurant, retail store, gym, bar, etc.). Data hierarchy in this scenario includes, for example, an account having a name, billing, and group. The group may include a location, and the location may include name, address, phone, email, hours of operation, cameras, and menu. The menu may include categories, and the categories may be defined by name, picture, schedule, and/or items. The items may include a name, schedule, description, picture, nutrition, recommended flag, and/or price. The location may also include vibe information. The vibes may include general vibes, cuisine, type of venue, etc. Additionally, user time series data, video time series data, and/or customer feedback may be provided for any given location. A user in the data hierarchy may be identified by name, email, and contact.

Additionally, use cases related to the business portal allocations 276 may include account information, location groups, location, menu control, and read-only data. Accounting information may include control account name, control billing, and control location groups. Location groups may include control user access and add/remove location. Location may include claim location through a search engine (e.g., Google My Business) or through postcard address verification. Location may also include control basic phonebook information (e.g., name, contact, hours, etc.). Location may include control menu, if applicable, control vibes, read time series data, and/or read customer feedback.

Vibe control may include a curated list of qualities that could apply to any experience at a given retail business location such as a venue. A business can select vibes with which to seed the recommended algorithm.

Menu control may include providing each location with a given menu. Menus may be organized by category. These categories may have names, tags (e.g., breakfast, lunch, dinner, brunch, kids, etc.), and can be scheduled as to when the category is available (e.g., always, weekends, between 6 PM and 10 PM daily, November 1 to January 1, etc.). The menu control may include items being located within each category. An item may be, for example, a drink, appetizer, main course, or the like. Items can be scheduled with the same pattern as categories (e.g., always, weekends, etc.).

The read-only data may include, for example, time series data such as anonymous mobile application user activity, video feeds, and feedback. Anonymous mobile application user activity may include liked/disliked venue, liked/disliked menu item, viewed venue details, viewed menu details, arrived at venue, left venue, and/or details/menu to arrived conversions.

Video feeds may include, for example, demographic information such as gender or age, or traffic location information such as wait area, bar, patio, etc. The customer feedback may include, for example, see like/dislike information, see free text response, and/or see vibes selected with feedback.

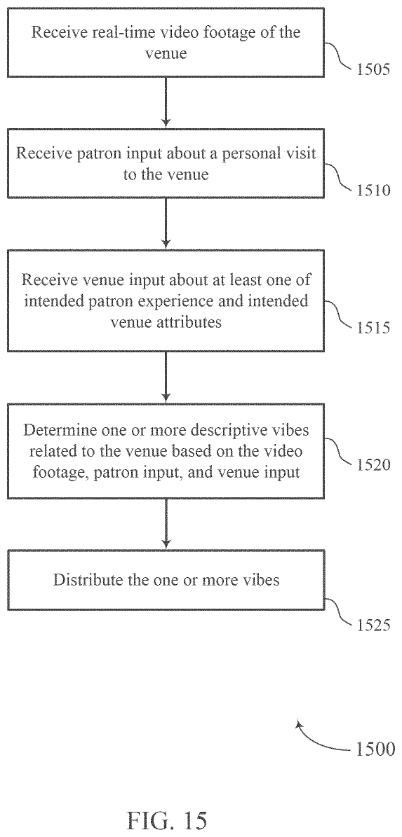

FIG. 15 shows a flow chart illustrating a method 1500 for rating menus in accordance with aspects of the present disclosure. The operations of method 1500 may be implemented by a device or its components as described herein. For example, the operation of method 1500 may be performed by a venue manager as described with reference to FIG. 1. The venue manager described with reference to FIG. 1 may operate to perform some or all of the functions associated with the systems 200-1400 described with reference to FIGS. 2-14. In some examples, a device may execute a set of instructions to control the functional elements of the device to perform the functions described herein. Additionally, or alternatively, a device may perform aspects of the functions described herein using special purpose hardware.

At 1505, the device may be operable to receive real-time video footage of a venue. At 1510, the device may receive patron input about a personal visit to the venue. At 1515, the device may receive menu input about at least one of intended patron experience and intended menu attributes. At 1520, the device may determine one or more descriptive vibes related to the menu based on the video footage, patron input, and/or venue input. At 1525, the device may publish the one or more vibes or otherwise distribute information about the vibes.

The operations of method 1500 may be performed according to the methods described herein. In some examples, aspects of the operations of method 1500 may be performed by a venue manager as described with reference to FIG. 1.

FIG. 16 shows a flow chart illustrating a method 1600 for recommending venues in accordance with aspects of the present disclosure. The operations of method 1600 may be implemented by a device or its components as described herein. For example, the operation of method 1600 may be performed by a venue manager as described with reference to FIG. 1. The venue manager described with reference to FIG. 1 may operate to perform some or all of the functions associated with the systems 200-1500 described with reference to FIGS. 2-15. In some examples, a device may execute a set of instructions to control the functional elements of the device to perform the functions described herein. Additionally, or alternatively, a device may perform aspects of the functions described herein using special purpose hardware.

At 1605, the device includes receiving patron input about a personal visit to a venue. At 1610, the device includes receiving venue input from the venue about at least one of intended patron experience and intended venue attributes. At 1615, the device may determine one or more descriptive vibes related to the venue based on the patron input and venue input. At 1620, the device may associate the patron input with the determined one or more vibes. At 1625, the device may recommend other venues to the patron that include the determined one or more vibes.

The operations of method 1600 may be performed according to the methods described herein. In some examples, aspects of the operations of method 1600 may be performed by a venue manager as described with reference to FIG. 1.

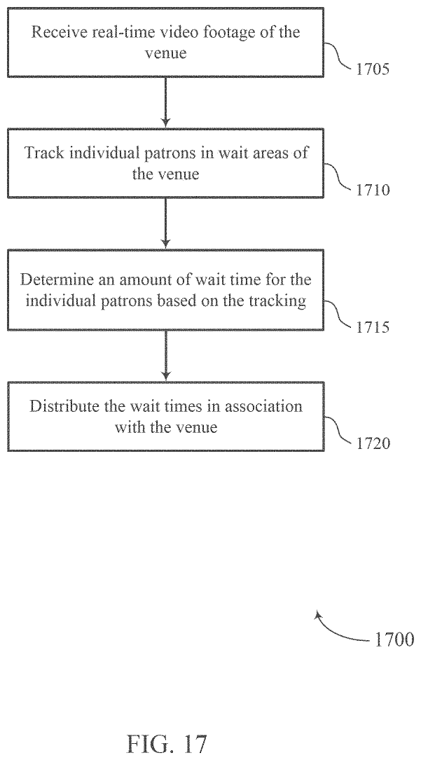

FIG. 17 shows a flow chart illustrating a method 1700 for determining wait times at a venue in accordance with aspects of the present disclosure. The operations of method 1700 may be implemented by a device or its components as described herein. For example, the operation of method 1700 may be performed by a venue manager as described with reference to FIG. 1. The venue manager described with reference to FIG. 1 may operate to perform some or all of the functions associated with the systems 200-1600 described with reference to FIGS. 2-16. In some examples, a device may execute a set of instructions to control the functional elements of the device to perform the functions described herein. Additionally, or alternatively, a device may perform aspects of the functions described herein using special purpose hardware.

At 1705, the device may receive real-time video footage of the venue. At 1710, the device may track individual patrons in wait areas of the venue. At 1715, the device may determine an amount of wait time for the individual patrons based on the tracking. At 1720, the device may distribute the wait times and association the venue.

The operations of method 1700 may be performed according to the methods described herein. In some examples, aspects of the operations of method 1700 may be performed by a venue manager as described with reference to FIG. 1.

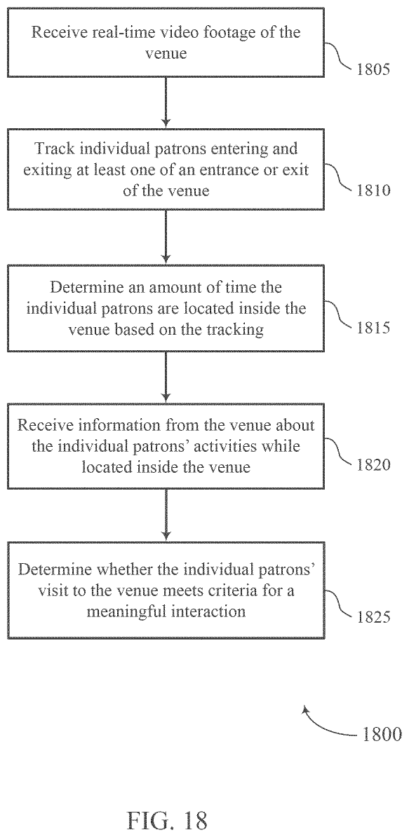

FIG. 18 shows a flow chart illustrating a method 1800 for determining dwell time of a patron at a venue in accordance with aspects of the present disclosure. The operations of method 1800 may be implemented by a device or its components as described herein. For example, the operation of method 1800 may be performed by a venue manager as described with reference to FIG. 1. The venue manager described with reference to FIG. 1 may operate to perform some or all of the functions associated with the systems 200-1700 described with reference to FIGS. 2-17. In some examples, a device may execute a set of instructions to control the functional elements of the device to perform the functions described herein. Additionally, or alternatively, a device may perform aspects of the functions described herein using special purpose hardware.

At 1805, the device may receive real-time video footage of the venue. At 1810, the device may track individual patrons entering and exiting at least one of an entrance or exit of the venue. At 1815, the device may determine an amount of time individual patrons are located inside the venue based on the tracking. At 1820, the device may receive information from the venue about the individual patron's activities while located inside the venue. At 1825, the device may determine whether the individual patron's visit to the venue meets criteria for a meaningful interaction.

The operations of method 1800 may be performed according to the methods described herein. In some examples, aspects of the operations of method 1800 may be performed by a venue manager as described with reference to FIG. 1.

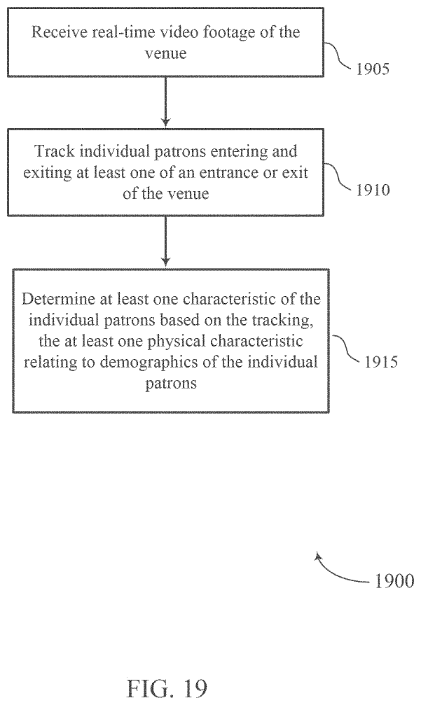

FIG. 19 shows a flow chart illustrating a method 1900 for determining demographics of visitors to a venue in accordance with aspects of the present disclosure. The operations of method 1900 may be implemented by a device or its components as described herein. For example, the operation of method 1900 may be performed by a venue manager as described with reference to FIG. 1. The venue manager described with reference to FIG. 1 may operate to perform some or all of the functions associated with the systems 200-1800 described with reference to FIGS. 2-18. In some examples, a device may execute a set of instructions to control the functional elements of the device to perform the functions described herein. Additionally, or alternatively, a device may perform aspects of the functions described herein using special purpose hardware.

At 1905, the device may receive real-time video footage of the venue. At 1910, the device may track individual patrons entering and exiting at least one of an entrance or exit of the venue. At 1915, the device may determine at least one characteristic of the individual patrons based on the tracking, wherein the at least one physical characteristic relates to demographics of the individual patrons.

The operations of method 1900 may be performed according to the methods described herein. In some examples, aspects of the operations of method 1900 may be performed by a venue manager as described with reference to FIG. 1.

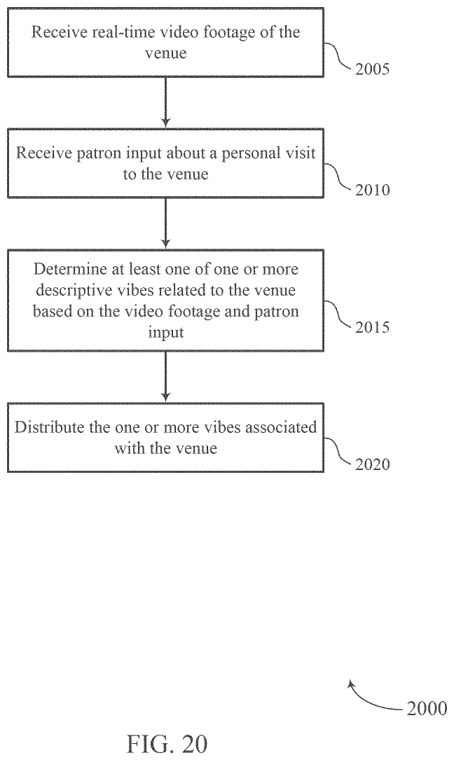

FIG. 20 shows a flow chart illustrating a method 2000 for determining atmosphere conditions at a venue in accordance with aspects of the present disclosure. The operations of method 2000 may be implemented by a device or its components as described herein. For example, the operation of method 2000 may be performed by a venue manager as described with reference to FIG. 1. The venue manager described with reference to FIG. 1 may operate to perform some or all of the functions associated with the systems 200-1900 described with reference to FIGS. 2-19. In some examples, a device may execute a set of instructions to control the functional elements of the device to perform the functions described herein. Additionally, or alternatively, a device may perform aspects of the functions described herein using special purpose hardware.

At 2005, the device may receive real-time video footage of the venue. At 2010, the device may receive patron input about a personal visit to the venue. At 2015, the device may determine at least one of one or more descriptive vibes related to the venue based on the video footage and patron input. At 2020, the device may publish the one or more vibes associated with the venue or otherwise distribute those vibes in association with the venue.

The operations of method 2000 may be performed according to the methods described herein. In some examples, aspects of the operations of method 2000 may be performed by a venue manager as described with reference to FIG. 1.

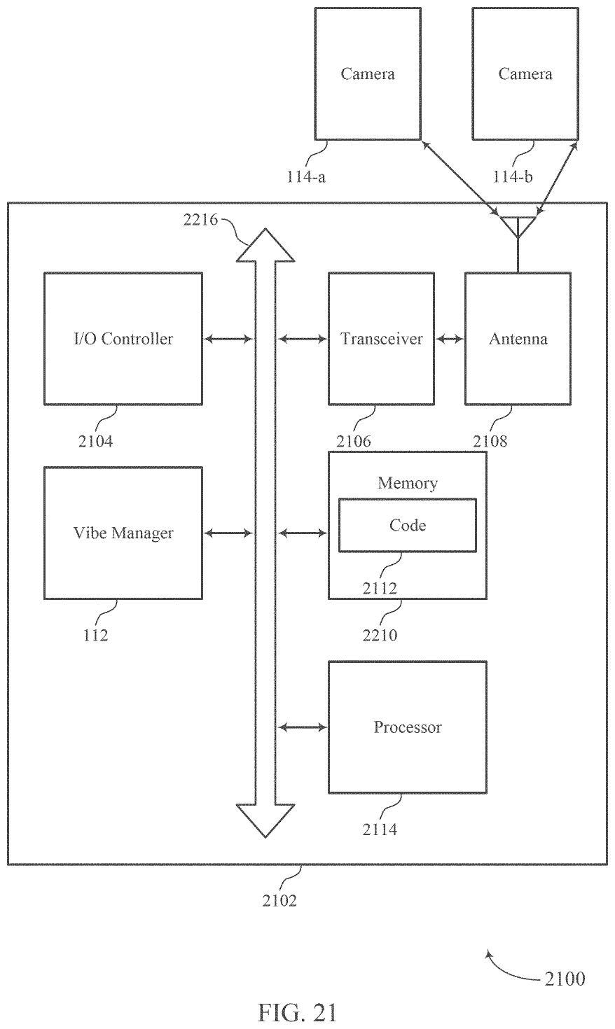

FIG. 21 shows a diagram of a system 2100 including a device 2102 that supports vibe-based considerations for a venue in accordance with aspects of the present disclosure. The device 2102 may be an example of or include the components of device 102 or a device as described herein. The device 2102 may include components for bi-directional voice and data communications including components for transmitting and receiving communications, including a vibe manager 112, an I/O controller 2104, a transceiver 2106, an antenna 2108, memory 2110, a processor 2114, and a coding manager 2150. These components may be in electronic communication via one or more buses (e.g., bus 2116).

The vibe manager 112 may provide any combination of the operations and functions described above related to the system architecture 200, the systems 300-1500, and the methods 1500-2000.

The I/O controller 2104 may manage input and output signals for the device 2102. The I/O controller 2104 may also manage peripherals not integrated into the device 2102. In some cases, the I/O controller 2104 may represent a physical connection or port to an external peripheral. In some cases, the I/O controller 2104 may utilize an operating system such as iOS®, ANDROID®, MS-DOS®, MS-WINDOWS®, OS/2®, UNIX®, LINUX®, or another known operating system. In other cases, the I/O controller 2104 may represent or interact with a modem, a keyboard, a mouse, a touchscreen, or a similar device. In some cases, the I/O controller 2104 may be implemented as part of a processor. In some cases, a user may interact with the device 2102 via the I/O controller 2104 or via hardware components controlled by the I/O controller 2104.

The transceiver 2106 may communicate bi-directionally, via one or more antennas, wired, or wireless links as described herein. For example, the transceiver 2106 may represent a wireless transceiver and may communicate bi-directionally with another wireless transceiver. The transceiver 2106 may also include a modem to modulate the packets and provide the modulated packets to the antennas for transmission, and to demodulate packets received from the antennas.

In some cases, the wireless device may include a single antenna 2108. However, in some cases the device may have more than one antenna 2108, which may be capable of concurrently transmitting or receiving multiple wireless transmissions.

The memory 2110 may include RAM and ROM. The memory 2110 may store computer-readable, computer-executable code 2112 including instructions that, when executed, cause the processor to perform various functions described herein. In some cases, the memory 2110 may contain, among other things, a BIOS which may control basic hardware or software operation such as the interaction with peripheral components or devices.

The processor 2114 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 2114 may be configured to operate a memory array using a memory controller. In other cases, a memory controller may be integrated into the processor 2114. The processor 2114 may be configured to execute computer-readable instructions stored in a memory (e.g., the memory 2110) to cause the device 2102 to perform various functions (e.g., functions or tasks supporting vibe related functions and other functions associated with the systems and methods disclosed herein).

The code 2112 may include instructions to implement aspects of the present disclosure, including instructions to support dynamic accessibility compliance of a website. The code 2112 may be stored in a non-transitory computer-readable medium such as system memory or other type of memory. In some cases, the code 2112 may not be directly executable by the processor 2114 but may cause a computer (e.g., when compiled and executed) to perform functions described herein.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, venue experience system 100 and/or system architecture 200 of FIGS. 1 and 2, respectively—may include one or more carriers.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical venues. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for rating venues, comprising:
receiving real-time video footage of a venue;
receiving patron input about a personal visit to the venue;
receiving venue input about at least one of intended patron experience and intended venue attributes;
determining one or more descriptive vibes related to the venue based on the video footage, patron input, and venue input;
distributing the one or more vibes.

2. The method of claim 1, further comprising:
associating the patron input with the determined one or more vibes;
recommending other venues to the patron that include the determined one or more vibes.

3. The method of claim 2, wherein:
the one or more vibes each represent a positively oriented adjective commonly used to describe experience from an emotional perspective.

4. The method of claim 2, further comprising:
determining wait time using the real-time video footage of the venue.

5. The method of claim 1, further comprising:
wherein the venue includes at least one of a restaurant, a gym, a bar, a store, and a dance club.

6. The method of claim 1, further comprising:
determining a bounce rate at the venue based on patron dwell time at the venue.

7. The method of claim 1, further comprising:
using the real-time video footage of the venue as a factor for determining the bounce rate.

8. The method of claim 1, wherein:
determining demographics at the venue based on the real-time video footage of the venue.

9. The method of claim 1, further comprising:
after determining the one or more vibes, identifying visual indicators from the real-time video footage of the venue related to the determined one or more vibes.

10. A method for recommending venues, comprising:
receiving patron input about a personal visit to a venue;
receiving venue input from the venue about at least one of intended patron experience and intended venue attributes;
determining one or more descriptive vibes related to the venue based on the patron input and venue input;
associating the patron input with the determined one or more vibes;
recommending other venues to the patron that include the determined one or more vibes.

11. The method of claim 10, further comprising:
receiving real-time video footage of the venue; and
determining the one or more vibes is also based on the real-time video footage.

12. A method for determining wait times at a venue, comprising:
receiving real-time video footage of the venue;
tracking individual patrons in wait areas of the venue;
determining an amount of wait time for the individual patrons based on the tracking;
distribute the wait times in association with the venue.

13. A method for determining dwell time of a patron at a venue, comprising:
receiving real-time video footage of the venue;
tracking individual patrons entering and exiting at least one of an entrance or exit of the venue;
determining an amount of time the individual patrons are located inside the venue based on the tracking;
receiving information from the venue about the individual patrons' activities while located inside the venue;
determine whether the individual patrons' visit to the venue meets criteria for a meaningful interaction.

14. A method for determining demographics of visitors to a venue, comprising:
receiving real-time video footage of the venue;
tracking individual patrons entering and exiting at least one of an entrance or exit of the venue;
determining at least one characteristic of the individual patrons based on the tracking, the at least one characteristic relating to demographics of the individual patrons.

15. The method of claim 14, wherein the at least one characteristic of the individual patrons includes at least one of age, race, gender, social status, occupation, income, level of education, marriage status, and sexual orientation.

16. A method for determining atmosphere conditions at a venue, comprising:
receiving real-time video footage of the venue;
receiving patron input about a personal visit to the venue;
determining at least one of one or more descriptive vibes related to the venue based on the video footage and patron input;
distributing the one or more vibes associated with the venue.

17. The method of claim 16, further comprising:
associating the patron input with the determined one or more vibes;
recommending other venues to the patron that include the determined one or more vibes.

18. The method of claim 16, further comprising:
detecting at least one of activities, décor, services being rendered, number of people, size of venue, and dress of patrons in the real-time video footage and associating the same with the determined one or more vibes.
